(19) United States
(12) Patent Application Publication
(10) Pub. No.: US 2019/0155994 A1
(43) Pub. Date: May 23, 2019

(54) Method of Facilitating Data-Exchange Between Clinical-Trial Sites and Clinical-Trial Sponsors

(71) Applicant: ORACLE MEDICAL RESEARCH INC., New York, NY (US)

(72) Inventors: Lenin Fermin, New York, NY (US); Johanna Mendoza, Old Tappan, NJ (US); Gioribe Antonio Feliz, Bronx, NY (US); Jose Espinal, Rye Brook, NY (US)

(21) Appl. No.: 15/816,929

(22) Filed: Nov. 17, 2017

(51) Int. Cl. G06F 19/00

(52) U.S. Cl. CPC G06F 19/363; G06Q 10/1095; G06F 19/322

(57) ABSTRACT

A method of facilitating data-exchange between clinical-trial sites and clinical-trial sponsors, makes use of clinical site profiles and a remote server to manage the clinical-trial site's information. A set of trial-facilitation processes is stored on the remote server and is used to enable a clinical-trial sponsor to manage all the aspects of a clinical trial. To initiate the method of the present invention, the clinical-trial sponsor provides a set of inclusion-exclusion criteria that defines the parameters of a proposed clinical trial. The inclusion-exclusion criteria are then compared to the capabilities of each clinical-trial site profile to identify a list of clinical-trial sites capable of performing the proposed clinical trial. The list of clinical trial sites is then sent to the clinical-trial sponsor and the clinical-trial sponsor is given the opportunity to manage the proposed clinical trial.

### FIELD OF THE INVENTION

The present invention relates generally to a clinical trial management system. More particularly, the present invention relates to a system that facilitates connecting clinical-trial sponsors with clinicians and clinical-trial sites that are capable of performing a desired clinical trial.

### BACKGROUND OF THE INVENTION

The present invention, the method of facilitating data-exchange between clinical-trial sites and clinical-trial sponsors, utilizes a set of technologies to enhance clinical trial study practices. The method of the present invention employs a robust system to provide the end user with study information, reports, and tools to conduct clinical trials in accordance with governmental rules, regulations, and best practices.

The method of the present invention is a conduit for information exchange between clinical trial investigators, pharmaceutical companies, hospitals, clinics, clinical research organizations, site management organizations, and clinical-site administrators. The present invention connects clinical trial investigators, research staffers, and physicians, seamlessly. Additionally, the method of the present invention optimizes communication between clinically relevant parties; enabling the clinical trial study team and referring physicians to communicate and share study information in a secure manner. Depending on the roles assigned, users have the capabilities of interacting with clinical-trial sponsor and clinical-trial sites to ensure adherence to the clinical trial research protocols. Furthermore, the method of the present invention provides a comprehensive dashboard, tracks approved IRB key regulatory documents during study start-up at a study level and subject level original protocol, enables the creation of subsequent contract amendments, ICFs, patient appointment cards, investigational brochures, recruitment materials, annual reviews, etc., right from a smartphone, desktop, or other computing device.

The method of the present invention has an informed consent functionality, which keeps track at a product level and subject level information to ensure subjects are being consented accordingly. The method of the present invention makes use of an informed consent functionality (ICF) to send an ICF reminder notification to the study team and their respective subjects when changes of the ICF have occurred. This message reminds the study team to inform the subject of the changes. If the subject agrees to continue with the study, the site should obtain patient consent. Utilizing the method of the present invention can facilitate the patient selection process to maximize recruitment and to help initiate the enrollment period. The driver is to help all bodies who conduct clinical trials to utilize this innovation platform to assist in the NDA application to FDA with the hope of obtaining a product approval to treat subject with unmet disease. Finally, the method of the present invention has a unique modular approach to allow security and delivery of study documents to its users. The Modules are managed dynamically based on administration's setting and assigned roles.

### BRIEF DESCRIPTION OF THE DRAWINGS

FIG. 1 is a block diagram illustrating the system overview of the present invention.

FIG. 2 is a flowchart describing the overall process followed by the method of the present invention.

FIG. 3 is a flowchart describing a sub-process for assessing the favorability score through the method of the present invention.

FIG. 4 is a flowchart describing a sub-process for gathering clinical-trial site data using a feasibility questionnaire through the method of the present invention.

FIG. 5 is a flowchart describing a sub-process for enabling communication between the clinical-trial sponsor and a group of desired clinical-trial sites through the method of the present invention.

FIG. 6 is a flowchart describing a sub-process for sending updates to informed consent protocols to the subjects of the desired clinical trial through the method of the present invention.

FIG. 7 is a flowchart describing a sub-process for accessing sponsor-coaching resources through the method of the present invention.

FIG. 8 is a flowchart describing a sub-process for accessing clinician-coaching resources through the method of the present invention.

FIG. 9 is a flowchart describing a sub-process for adding clinical-trial data to a data log through the method of the present invention.

FIG. 10 is a flowchart describing a sub-process for generating clinical sponsor-focused reports on the clinical-trial data through the method of the present invention.

FIG. 11 is a flowchart describing a sub-process for generating clinician-focused reports on the clinical-trial data through the method of the present invention.

FIG. 12 is a flowchart describing a sub-process for scheduling subject appointments through the method of the present invention.

FIG. 13 is a flowchart describing a sub-process for recording notes about a scheduled appointment through the method of the present invention.

FIG. 14 is a flowchart describing a sub-process enabling the clinician to view scheduled appointments through the method of the present invention.

FIG. 15 is a flowchart describing a sub-process enabling the clinical-trial sponsor to view scheduled appointments through the method of the present invention.

FIG. 16 is a flowchart describing a sub-process for alerting a clinician of an upcoming medical license expiration date through the method of the present invention.

FIG. 17 is a flowchart describing a sub-process for monitoring the clinical trial environment using the plurality of environmental sensors through the method of the present invention.

### DETAIL DESCRIPTIONS OF THE INVENTION

All illustrations of the drawings are for the purpose of describing selected versions of the present invention and are not intended to limit the scope of the present invention.

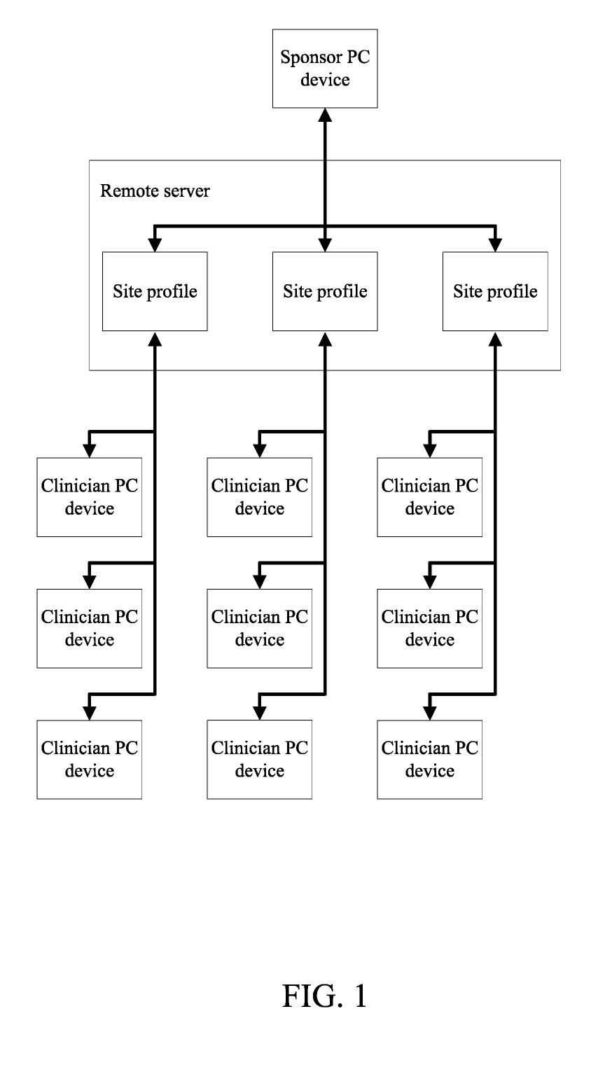

As can be seen in FIG. 1 through FIG. 17, the preferred embodiment of the present invention, the method of facilitating data-exchange between clinical-trial sites and clinical-trial sponsors, enables clinical-trial sponsors to connect with and manage clinical-trial sites that are capable of performing the research required to execute one or more desired clinical trials. The term “clinical-trial site” is used herein to refer to a hospital or medical research facility that employs clinicians and healthcare personnel. Additionally, the term “clinical-trial sponsor” is used herein to refer to an individual or an organization that would like to have a clinical trial performed by one or more clinical-trial sites. The method of the present invention is used to provide a clinical-trial sponsor with a list of clinical-trial sites that have the clinical resources—that is, the personnel, equipment, and subjects—required to effectively perform a desired clinical trial. To accomplish this, the method of the present invention distributes feasibility questionnaires to multiple clinical-trial sites. These feasibility questionnaires are used to determine what clinical resources are available to each clinical-trial site. The method of the present invention then searches for any inclusion-exclusion criteria that the clinical-trial sponsor has made publicly available. Alternatively, the clinical-trial sponsor is able to use the method of the present invention to privately specify a desired set of inclusion-exclusion criteria. The term “inclusion-exclusion criteria” is used herein to refer to the various clinical resources necessary to perform the desired clinical trial. The method of the present invention then creates a ranked list of clinical-trial sites that satisfy the inclusion-exclusion criteria. The clinical-trial sponsor is then notified of the ranked clinical-trial sites and given the opportunity to enter into contractual agreements for performing the clinical trial. Afterward, the method of the present invention enables the clinical-trial sponsor and the clinical-trial site to perform various clinical-trial management processes that include, but are not limited to, exchanging information, updating contracts, modifying account permissions, and completing compliance coaching exercises.

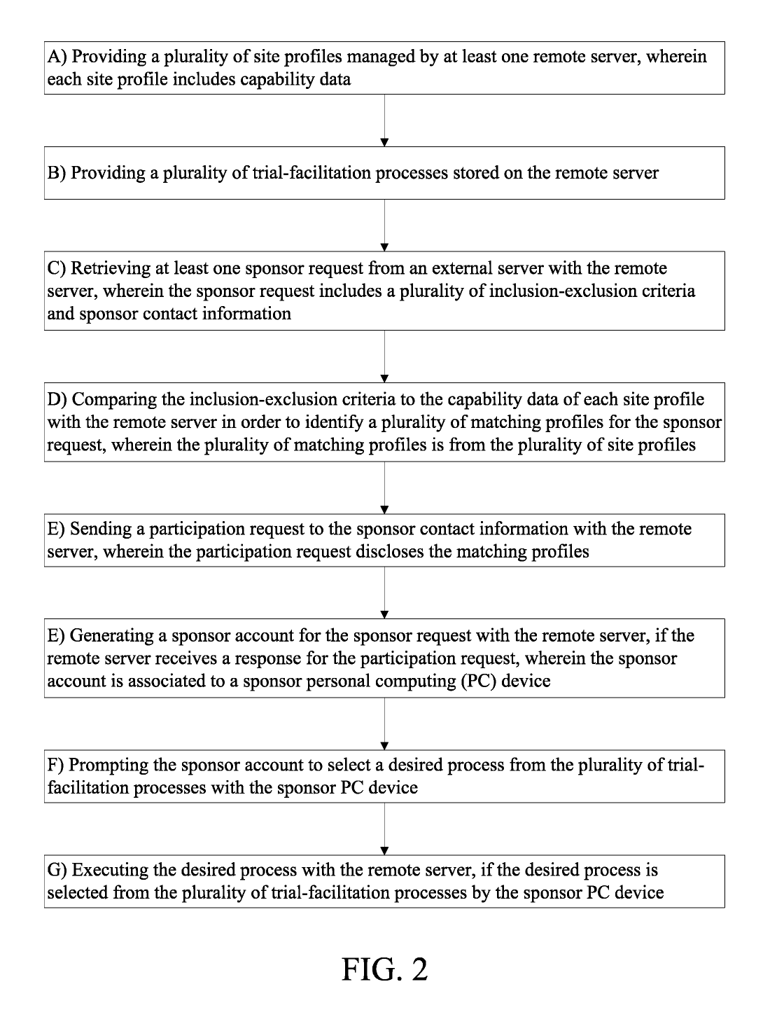

As can be seen in FIG. 1 and FIG. 2, to achieve the-above described functionalities, the method of the present invention requires a system of connected devices. As such, the system required to execute the method of the present invention provides a plurality of site profiles managed by at least one remote server (Step A). Each of the plurality of site profiles is a digital record for a distinct clinical-trial site. Furthermore, each site profile includes capability data. The remote server is used to facilitate communication between the plurality of clinical-trial sites and the clinical-trial sponsor. Moreover, the remote server is used to execute a number of internal processes for the method of the present invention and is used to store data related to the desired clinical trial. Additionally, the system required to execute the method of the present invention provides a plurality of trial-facilitation processes stored on the remote server (Step B). Each of the trial-facilitation processes is a sub-process that enables the clinical-trial sponsor to use the method of the present invention to perform various tasks that include, but are not limited to, sending and requesting information, generating reports, accessing coaching materials, updating contracts and user permissions, updating subjects of informed consent, and checking the status of any connected environmental sensors.

As can be seen in FIG. 1 and FIG. 2, the overall method of the present invention is enabled by executing a series of steps, which enable clinical-trial sponsors to effectively manage clinical trials that are being performed at one or more clinical-trial site. As such, the overall method of the present invention begins by retrieving at least one sponsor request from an external server with the remote server (Step C). The sponsor request is a listing of the clinical-trial sponsor's requirements for the desired clinical trial. This information is stored on an external server that contains a repository of clinical-trial information. Specifically, the sponsor request includes a plurality of inclusion-exclusion criteria and sponsor contact information. The sponsor contact information is a digital record of how the clinical-trial sponsor can be contacted before, during, and after the clinical trial. In this step, the overall method of the present invention gathers information about potential clinical trials from external sources. Once gathered, the overall method of the present invention continues by comparing the inclusion-exclusion criteria to the capability data of each site profile with the remote server in order to identify a plurality of matching profiles for the sponsor request (Step D). The plurality of matching profiles is a set that includes all of the clinical-trial sites that have the clinical resources required to perform the desired clinical trial. Specifically, the plurality of matching profiles is from the plurality of site profiles. Step D of the overall method of the present invention creates a ranked list of the plurality of matching profiles by comparing the clinical resource data for each clinical-trial site to the inclusion-exclusion criteria that is supplied by the clinical-trial sponsor. In this ranked list, the clinical-trial sites with clinical resources that can best satisfy the inclusion-exclusion criteria are ranked higher than the clinical-trial sites that are less able to satisfy the inclusion-exclusion criteria. The overall method of the present invention continues by sending a participation request to the sponsor contact information with the remote server (Step E). The participation request is a message that invites the clinical-trial sponsor to employ the method of the present invention as a tool for managing the desired clinical trial. By including the ranked list of matching profiles, the participation request conveys the value that using the method of the present invention adds to the clinical-trial sponsor. Alternatively, the participation request may simply include an invitation and withhold the ranked list of matching sites from the clinical-trial sponsor until the clinical-trial sponsor creates an account to use the method of the present invention as a clinical trial management system. The method of the present invention can include an interactive dashboard with the participation request. This interactive dashboard enables the clinical-trial sponsor to view various pieces of information about the clinical-trial sites included in the ranked list of matching profiles. Furthermore, this interactive dashboard goves the clinical-trial sponsor the opportunity to reorganize the clinical-trial site data as desired.

As can be seen in FIG. 1 and FIG. 2, once the overall method of the present invention has invited the clinical-trial sponsor to participate, the process waits for a response from the clinical-trial sponsor. If no response is received, then the overall method of the present invention ends. However, if the clinical-trial sponsor would like to use the method of the present invention as a clinical trial management system, then the overall method of the present invention continues by generating a sponsor account for the sponsor request with the remote server, if the remote server receives a response for the participation request (Step F). The sponsor account is a unique digital record that contains the clinical-trial sponsor's information and is used to access the method of the present invention. Additionally, the sponsor account is associated to a sponsor personal computing (PC) device. The sponsor PC device is a computing device that the clinical-trial sponsor uses to interact with the method of the present invention. Specifically, the sponsor PC device can be chosen from a group of computing devices that includes, but is not limited to, laptops, tablet PC devices, smartphones, and desktop PC devices. The overall method of the present invention continues by prompting the sponsor account to select a desired process from the plurality of trial-facilitation processes with the sponsor PC device (Step G). After creating the sponsor account, the sponsor PC device is used to present an interface that functions as a graphical dashboard, through which the clinical-trial sponsor is able to view clinical trial information and issue commands. The desired process is the command that the clinical-trial sponsor would like to have executed by the method of the present invention. The overall method of the present invention continues by executing the desired process with the remote server, if the desired process is selected from the plurality of trial-facilitation processes by the sponsor PC device (Step H). Accordingly, the method of the present invention then executes the sub-process that is associated to the desired process.

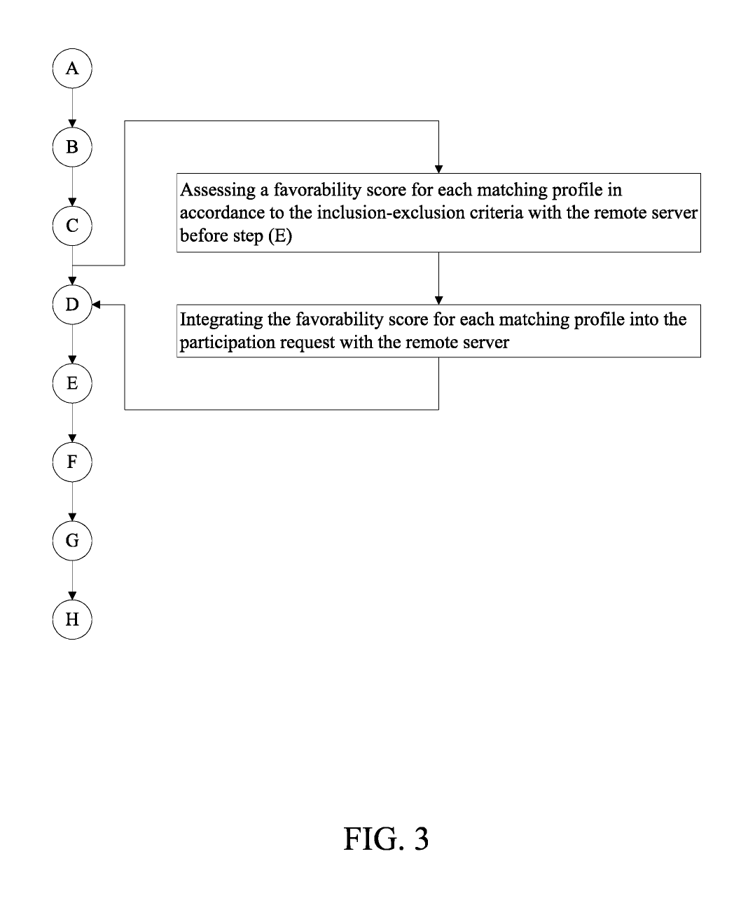

As can be seen in FIG. 3, the method of the present invention includes a sub-process for creating the ranked list of matching profiles. The sub-process begins by assessing a favorability score for each matching profile in accordance to the inclusion-exclusion criteria with the remote server before Step E. The favorability score is a quantifiable metric that is used to identify how well a given clinical-trial site is able to perform the desired clinical trial. Specifically, the favorability score for the given clinical-trial site is derived by comparing the capability data that is included in the site profile to the inclusion-exclusion criteria that was provided by the clinical-trial sponsor. Once the favorability score is determined for each of the plurality of matching profiles, the sub-process continues by integrating the favorability score for each matching profile into the participation request with the remote server. This integration is accomplished by organizing the plurality of matching profiles into the ranked list of matching profiles. In the ranked list of matching profiles, clinical-trial sites with higher favorability scores are ranked higher than clinical-trial sites with lower favorability scores. The ranked list of matching profiles includes a favorability threshold to restrict the clinical-trial sites that will be included in the ranked list of matching profiles. That is, clinical-trial sites with favorability scores that are less than the favorability threshold will not be included in the ranked list of matching profiles.

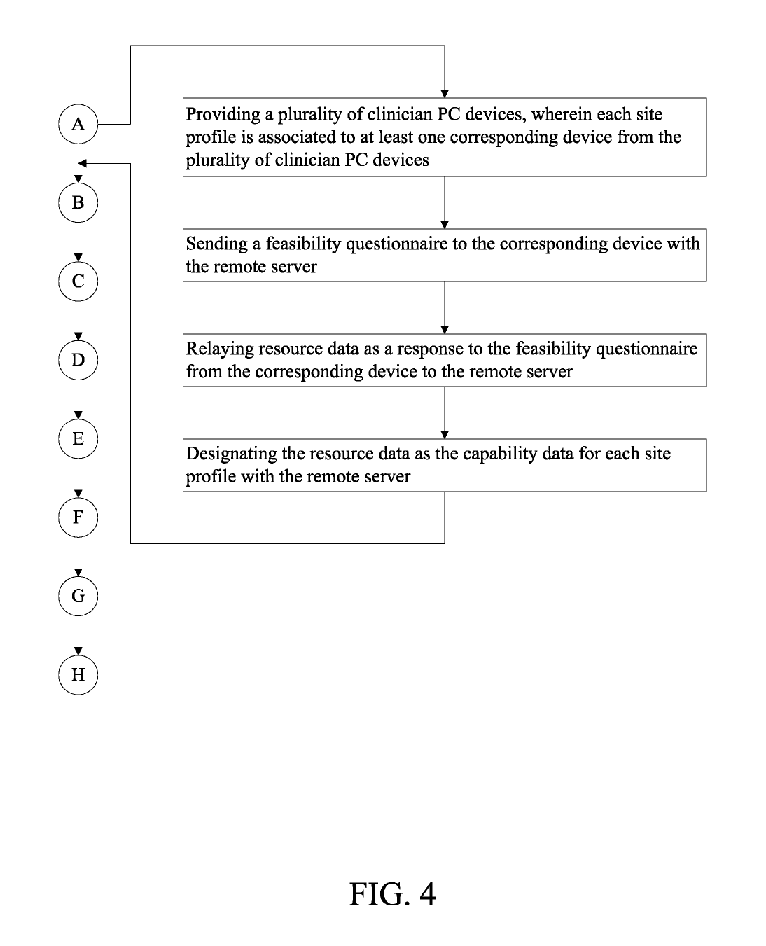

As can be seen in FIG. 4, the system required to execute the method of the present invention makes use of computing devices to relay information between the clinical-trial sponsor and the appropriate medical personnel at the clinical-trial sites. To accomplish this, the system provides a plurality of clinician PC devices. Each of the plurality of clinician PC devices is used by a clinician, or other authorized medical professional, to interact with the method of the present invention. Furthermore, each site profile is associated to at least one corresponding device from the plurality of clinician PC devices. That is, the site profile for each clinical-trial site can be accessed through an authorized PC device that is associated with the clinical-trial site. Additionally, any PC device may be authorized to access the site profile if a user has sufficient credentials. The method of the present invention makes use of this system to execute a sub-process that distributes feasibility questionnaires to the medical professionals who are employed by clinical-trial sites. This sub-process begins by sending a feasibility questionnaire to the corresponding device with the remote server. The feasibility questionnaire is a form that is used to measure a clinical-trial site's available clinical resources. The medical professional who is authorized to assess the clinical-trial site's available resources then fills out the feasibility questionnaire. The sub-process continues by relaying resource data as a response to the feasibility questionnaire from the corresponding device to the remote server. Once completed, the medical professional transfers the feasibility questionnaire to the remote server. The resource data is the information about the available clinical resources that was entered into the feasibility questionnaire. The sub-process concludes by designating the resource data as the capability data for each site profile with the remote server. The final step of this sub-process integrates the clinical resource data, which was supplied by the medical professional, into the site profile to which the medical professional is associated.

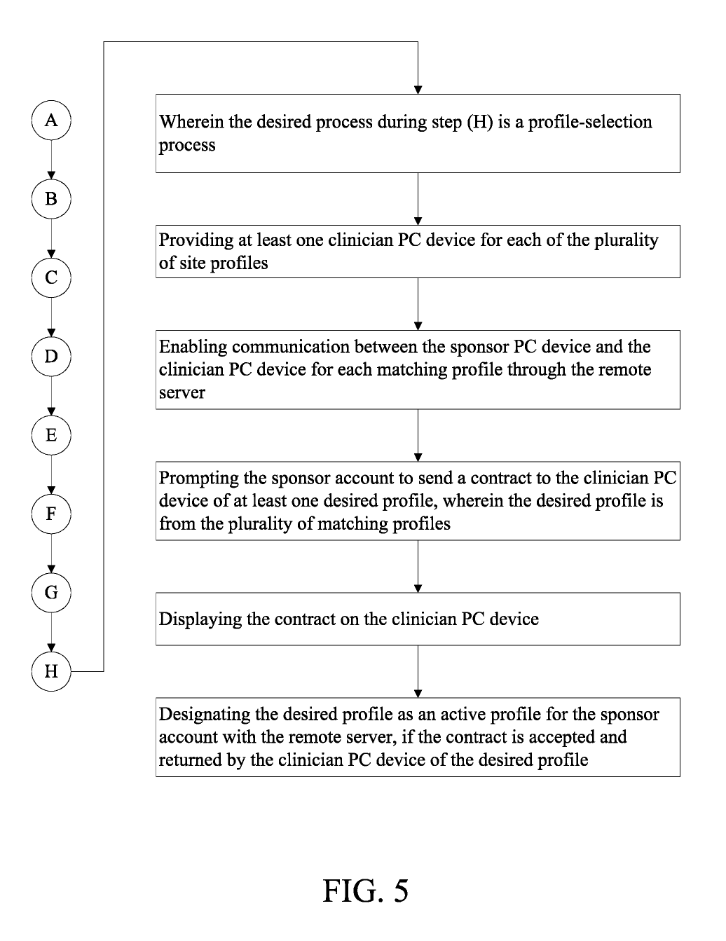

As can be seen in FIG. 5, the method of the present invention includes a sub-process that enables clinical-trial sponsors and clinical-trial sites to negotiate contracts and outline the scope of work for the desired clinical trial. This sub-process is initialized when the desired process during Step H is a profile-selection process (Step I). The profile-selection process is the sub-process that the clinical-trial sponsor uses to select the clinical-trial site, or sites, that will perform the desired clinical trial. As previously stated, the system for executing the method of the present invention provides at least one clinician PC device for each of the plurality of site profiles (Step J). The sub-process continues by enabling communication between the sponsor PC device and the clinician PC device for each matching profile through the remote server (Step K). After the clinical-trial sponsor has created a sponsor account, the clinical-trial sponsor is given the opportunity to communicate with any of the clinical-trial sites that are identified in the plurality of matching profiles. The sub-process continues by prompting the sponsor account to send a contract to the clinician PC device of at least one desired profile (Step L). The desired profile is the site profile that is associated to a clinical-trial site that the clinical-trial sponsor would like to perform the desired clinical trial. The sub-process continues by displaying the contract on the clinician PC device (Step M). Finally, the sub-process concludes by designating the desired profile as an active profile for the sponsor account with the remote server, if the contract is accepted and returned by the clinician PC device of the desired profile (Step N). Step L, Step M, and Step N are used to cover the contract negotiation process that occurs between the clinical-trial sponsor and the clinical-trial site. Both the clinical-trial sponsor and the clinical-trial site are given opportunities to respond and make changes until both parties arrive at an acceptable contract. Once the clinical-trial sponsor and the clinical-trial site agree upon a contract, the site profile for the clinical-trial site becomes an active profile for the clinical-trial sponsor's sponsor account. That is, the clinical-trial sponsor is now able to manage the operations of the clinical trial that is being performed by the clinical-trial site, which is now an active profile.

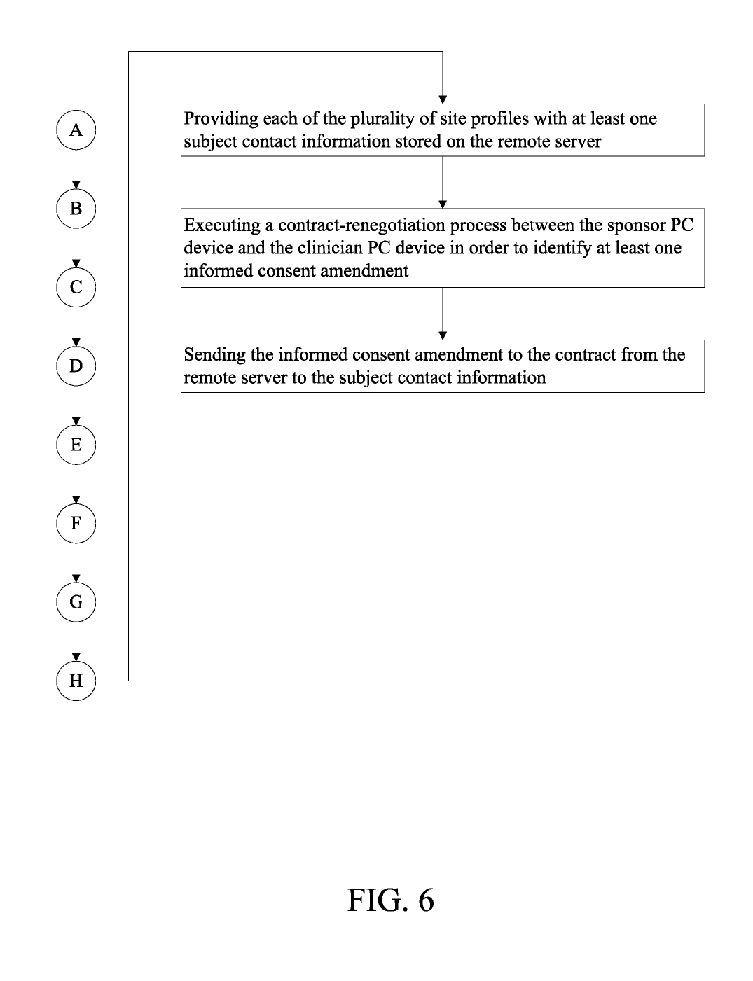

As can be seen in FIG. 6, the method of the present invention includes a sub-process that sends updated information to the subjects of the desired clinical trial. To accomplish this, the active profile must provide subject contact information for at least one subject. This subject contact information is associated with the active profile. The sub-process begins by executing a contract-renegotiation process between the sponsor PC device and the clinician PC device in order to identify at least one informed consent amendment. The contract-renegotiation process enables the clinical-trial sponsor and the clinical-trial site to modify the terms of the contract as appropriate. Additionally, the contract-renegotiation process enables the clinical-trial sponsor, and the clinical-trial site to update subject protocols and parameters that affect informed consent. The sub-process updates the contract if the clinical-trial sponsor and the clinical-trial site agree upon an informed consent amendment to the contract during the contract-renegotiation process. Finally, the sub-process concludes by sending the informed consent amendment to the contract from the remote server to the subject contact information. As a result, the subjects are kept abreast of any changes to protocols and are able to give informed consent. In addition to transmitting protocol updates to the subjects, the method of the present invention can be used to transmit other forms and information to the subjects including, but not limited to, appointment notifications, emergency messages, and treatment progress.

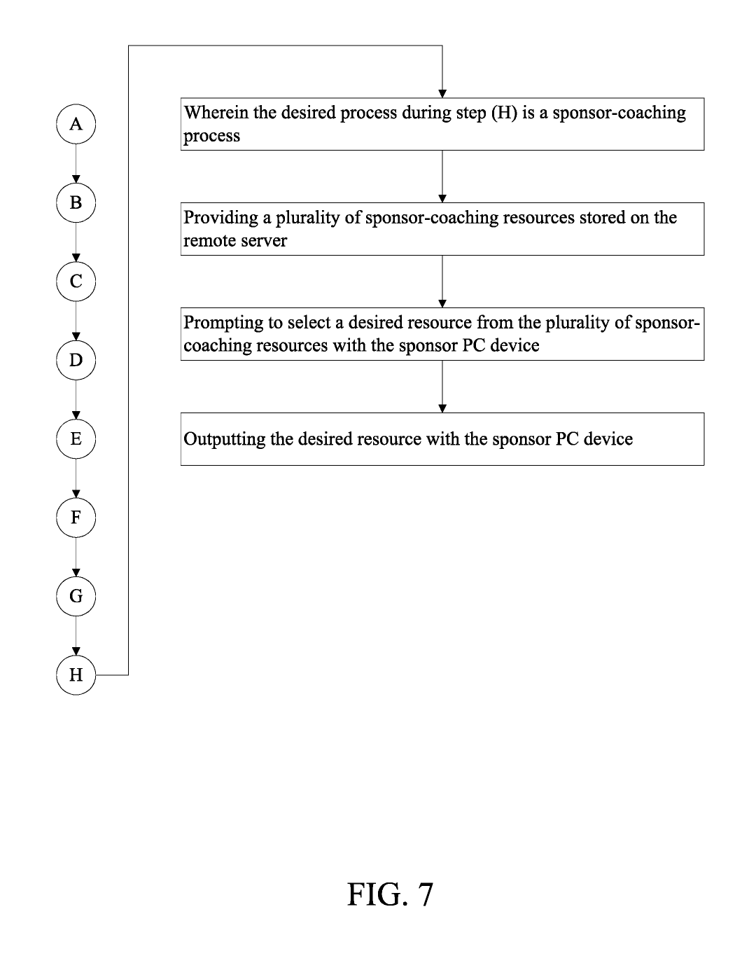

As can be seen in FIG. 7, the method of the present invention includes a sub-process that enables clinical-trial sponsors to review compliance-coaching materials when preparing for an inspection. This sub-process is initiated when the desired process during Step H is a sponsor-coaching process. The sponsor-coaching process is enabled because the system required to execute the method of the present invention provides a plurality of sponsor-coaching resources stored on the remote server. The plurality of sponsor-coaching resources is a collection of files that the clinical-trial sponsor can access to gain the knowledge required to ensure compliance with regulatory standards. Furthermore, the sponsor-coaching resources contains coaching aids in many formats which include but are not limited to, videos, audio files, text documents, and slide-based presentations. The sub-process continues by prompting to select a desired resource from the plurality of sponsor-coaching resources with the sponsor PC device. Finally, the sub-process concludes by outputting the desired resource with the sponsor PC device. Accordingly, the clinical-trial sponsor is able to select and then review any of the sponsor-coaching resources that are appropriate.

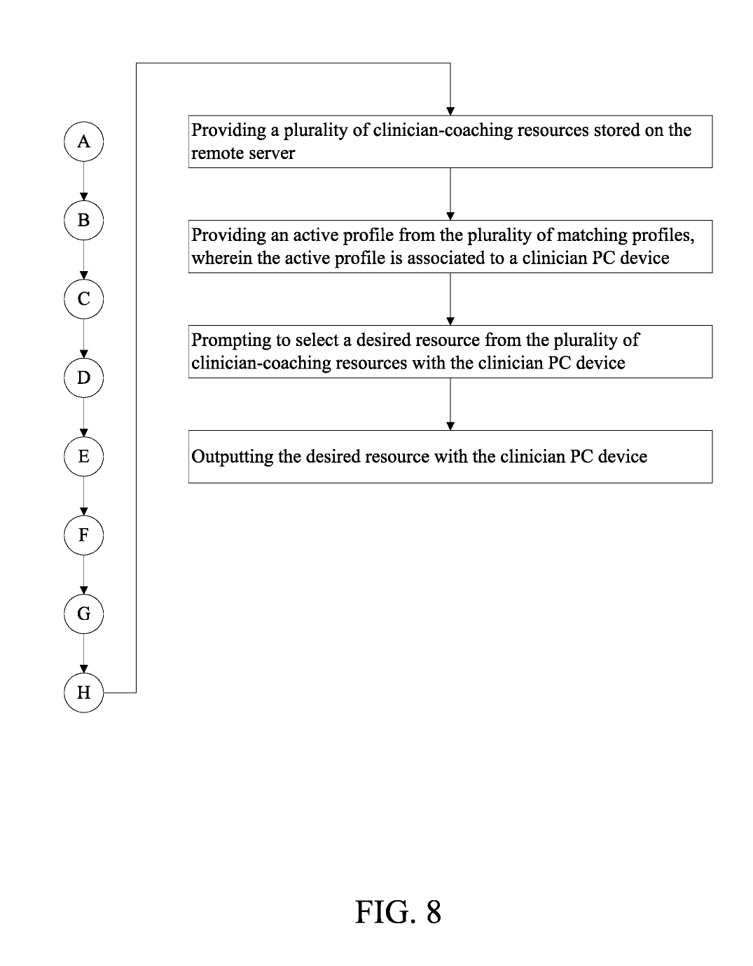

As can be seen in FIG. 8, the method of the present invention includes a sub-process that enables the medical professionals working at clinical-trial sites to review compliance-coaching materials when preparing for an inspection. To facilitate this, the system required to execute the method of the present invention provides a plurality of clinician-coaching resources stored on the remote server. The plurality of clinician-coaching resources is a collection of files that the clinical-trial site can access to gain the knowledge required to ensure compliance with regulatory standards. Furthermore, the clinician-coaching resources contains coaching aids in many formats which include but are not limited to, videos, audio files, text documents, and slide-based presentations. The sub-process begins by prompting to select a desired resource from the plurality of clinician-coaching resources with the clinician PC device. Finally, the sub-process concludes by outputting the desired resource with the clinician PC device. Accordingly, the clinical-trial site is able to select and then review any of the clinician-coaching resources that are appropriate.

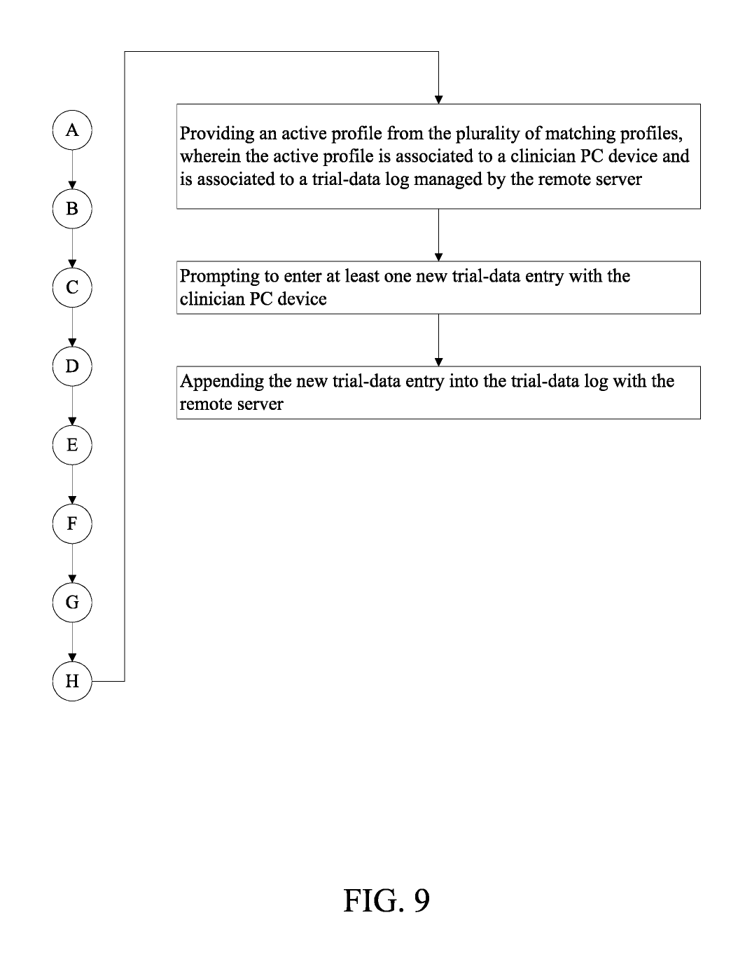

As can be seen in FIG. 9, the method of the present invention includes a sub-process that enables the clinical-trial site to report and record information that is pertinent to the desired clinical trial. The system required to execute the method of the present invention facilitates this sub-process by providing a trial-data log managed by the remote server. The trial-data log is a repository for all the data that is gathered during the desired clinical trial. The sub-process begins by prompting to enter at least one new trial-data entry with the clinician PC device. The new trial-data entry is a piece of information that was gathered by the clinical-trial site, but has yet to be entered into the trial-data log. The sub-process concludes by appending the new trial-data entry into the trial-data log with the remote server. Accordingly, the new trial-data entry is stored on the remote server and can be accessed by both the clinical-trial sponsor and the clinical trial site.

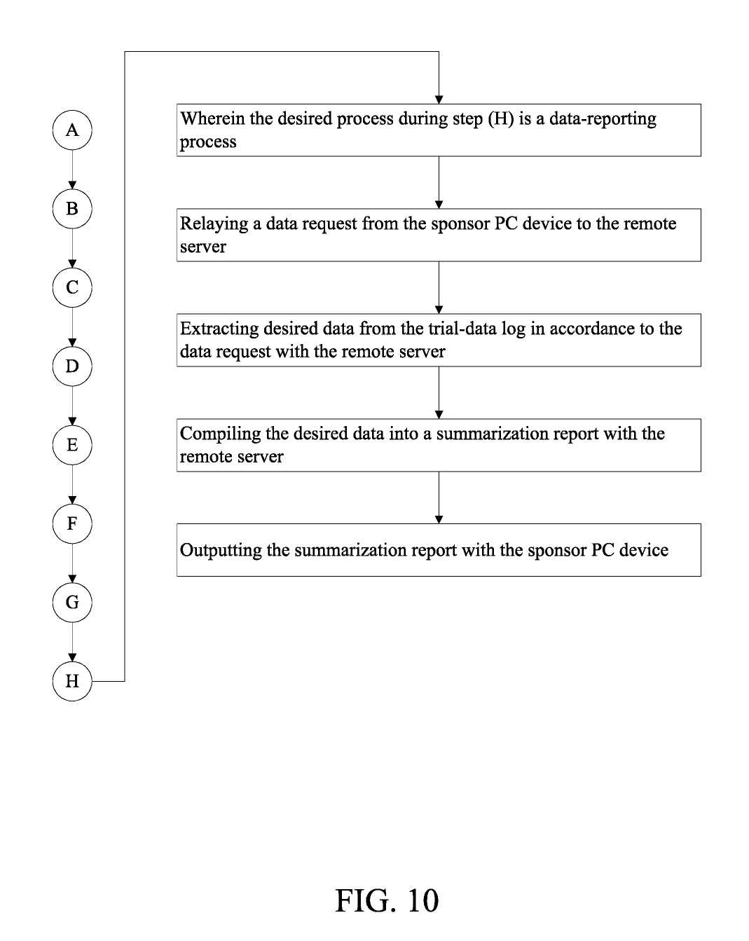

As can be seen in FIG. 10, the method of the present invention includes a sub-process that enables the clinical-trial sponsor to access and review the data that is stored in the trial-data log. This sub-process is initiated when the desired process during Step H is a data-reporting process. The data-reporting process enables the clinical-trial sponsor to specify a dataset that should be used to generate a report. This sub-process begins by relaying a data request from the sponsor PC device to the remote server. The data request contains a query that outlines the piece of data that the clinical-trial sponsor would like to view. The sub-process continues by extracting desired data from the trial-data log in accordance to the data request with the remote server. The desired data is the collection of data that satisfies the clinical-trial sponsor's query. Furthermore, the data-reporting process can be used to provide the clinical-trial sponsor with information that includes, but is not limited to, the number of active clinicians, the frequency of subject appointments, and the number of subjects. The sub-process continues by compiling the desired data into a summarization report with the remote server. The summarization report is a formatted report that contains the desired data. Additionally, the summarization report can be formatted into a graphical chart, an interactive interface, or a text document. Furthermore, the format of the summarization report is specified by the clinical-trial sponsor in the data request. The sub-process concludes by outputting the summarization report with the sponsor PC device. Accordingly, the clinical-trial sponsor is presented with the data that was requested in a desired format.

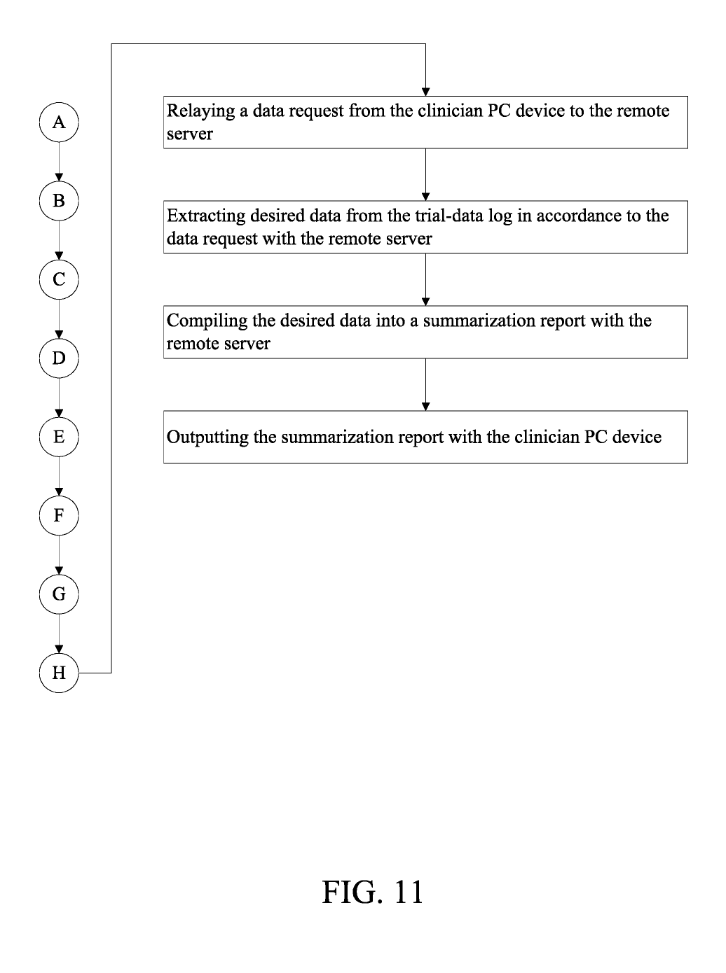

As can be seen in FIG. 11, the method of the present invention includes a sub-process that enables the clinical-trial site to access and review the data that is stored in the trial-data log. This sub-process begins by relaying a data request from the clinician PC device to the remote server. The data request contains a query that outlines the piece of data that the clinical-trial site would like to view. The sub-process continues by extracting desired data from the trial-data log in accordance to the data request with the remote server. The desired data is the collection of data that satisfies the clinical-trial site's query. Furthermore, the data-reporting process can be used to provide the clinical-trial site with information that includes, but is not limited to, the number of active clinicians, the frequency of subject appointments, and the number of subjects. The sub-process continues by compiling the desired data into a summarization report with the remote server. The summarization report is a formatted report that contains the desired data. Additionally, the summarization report can be formatted into a graphical chart, an interactive interface, or a text document. Furthermore, the format of the summarization report is specified by the clinical-trial site in the data request. The sub-process concludes by outputting the summarization report with the clinician PC device. Accordingly, the clinical-trial site is presented with the data that was requested in a desired format.

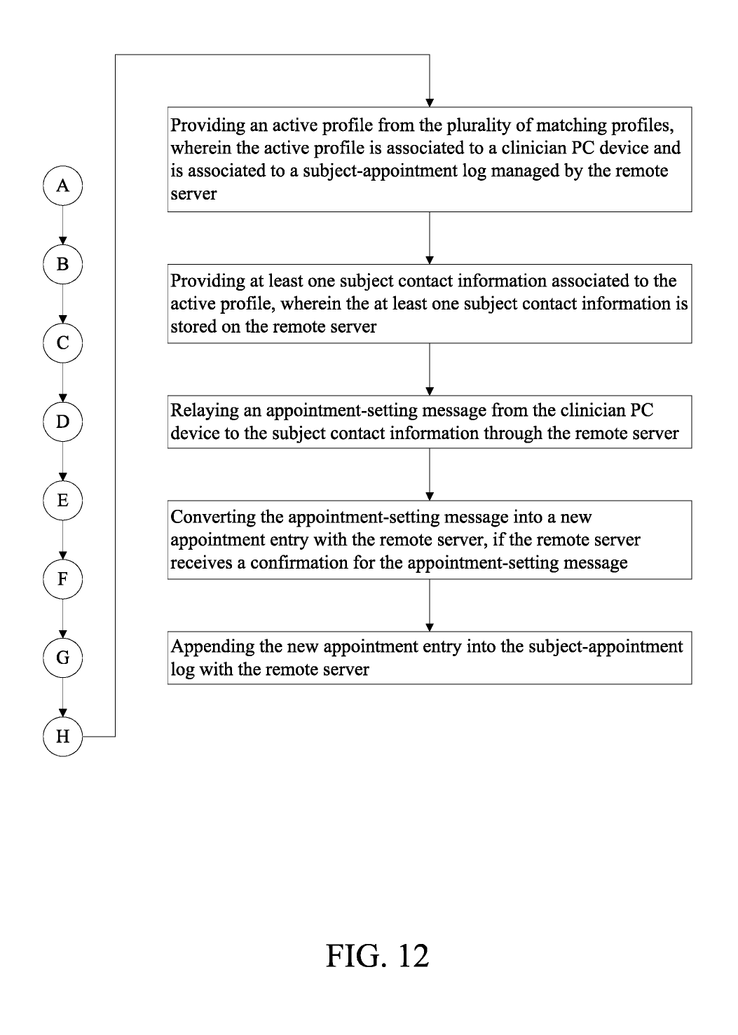

As can be seen in FIG. 12, the method of the present invention includes a sub-process that enables the clinical-trial site to schedule appointments with subjects and then log information about each scheduled appointment. The system required to execute the method of the present invention facilitates this sub-process by providing a subject-appointment log that is associated with each active profile and is managed by the remote server (Step R). As heretofore disclosed, the system required to execute the method of the present invention provides at least one piece of subject contact information for the active profile (Step S). The sub-process for scheduling subject appointments begins by relaying an appointment-setting message from the clinician PC device to the subject contact information through the remote server (Step T). The appointment-setting message is a message that contains the date and time of an upcoming appointment. Additionally, the appointment-setting message contains an invitation for the subject to respond with a confirmation of the appointment. The sub-process continues by converting the appointment-setting message into a new appointment entry with the remote server, if the remote server receives a confirmation for the appointment-setting message (Step U). The new-appointment entry is a formatted version of the appointment-setting message that contains only the information that is required to form an entry in the subject-appointment log. The sub-process concludes by appending the new appointment entry into the subject-appointment log with the remote server. Once the appointment has been confirmed by the subject, the sub-process updates the subject-appointment log so that the information is available to the clinical-trial sponsor, as well as all of the authorized medical personnel at the clinical-trial site.

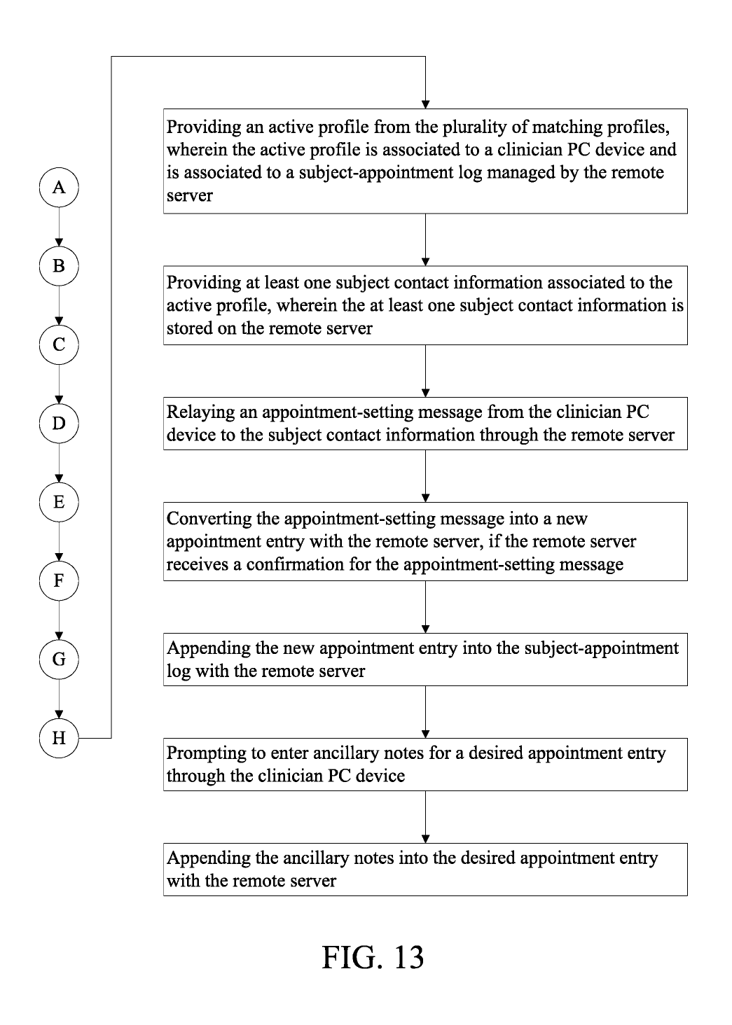

As can be seen in FIG. 13, the method of the present invention includes a sub-process that enables medical professionals to enter notes taken during a subject appointment into a corresponding entry in the subject-appointment log. The sub-process begins by prompting to enter ancillary notes for a desired appointment entry through the clinician PC device. The ancillary notes can contain any information that the medical professional records during a subject appointment. Furthermore, the desired appointment entry is an entry in the subject-appointment log that corresponds to the notes which were taken. The sub-process concludes by appending the ancillary notes into the desired appointment entry with the remote server. For example, if a clinician sets an appointment with Subject X for Monday July 9 at 3 PM, then the subject-appointment log will be updated to contain an entry for Subject X on Monday July 9 at 3 PM. If the clinician takes notes during the appointment with Subject X, then these notes will be classified as ancillary notes and will be integrated into the entry of the subject-appointment log for Subject X on Monday July 9 at 3 PM.

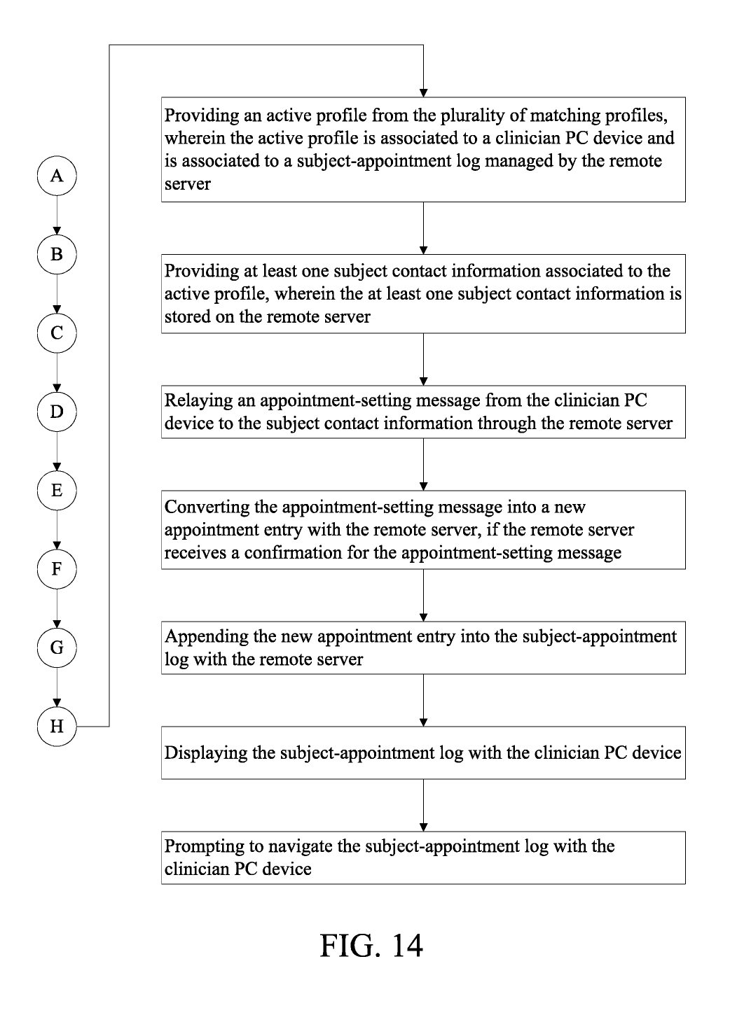

As can be seen in FIG. 14, the method of the present invention includes a sub-process that enables the medical professional at a clinical-trial site to view the appointments that are stored in the subject-appointment log. The sub-process begins by displaying the subject-appointment log with the clinician PC device. The sub-process then prompts to navigate the subject-appointment log with the clinician PC device. The medical professional is then able to perform various operations on the subject-appointment log including, but not limited to, searching for a specific appointment, finding the appointments for a specific clinician, and removing canceled appointments from the subject-appointment log.

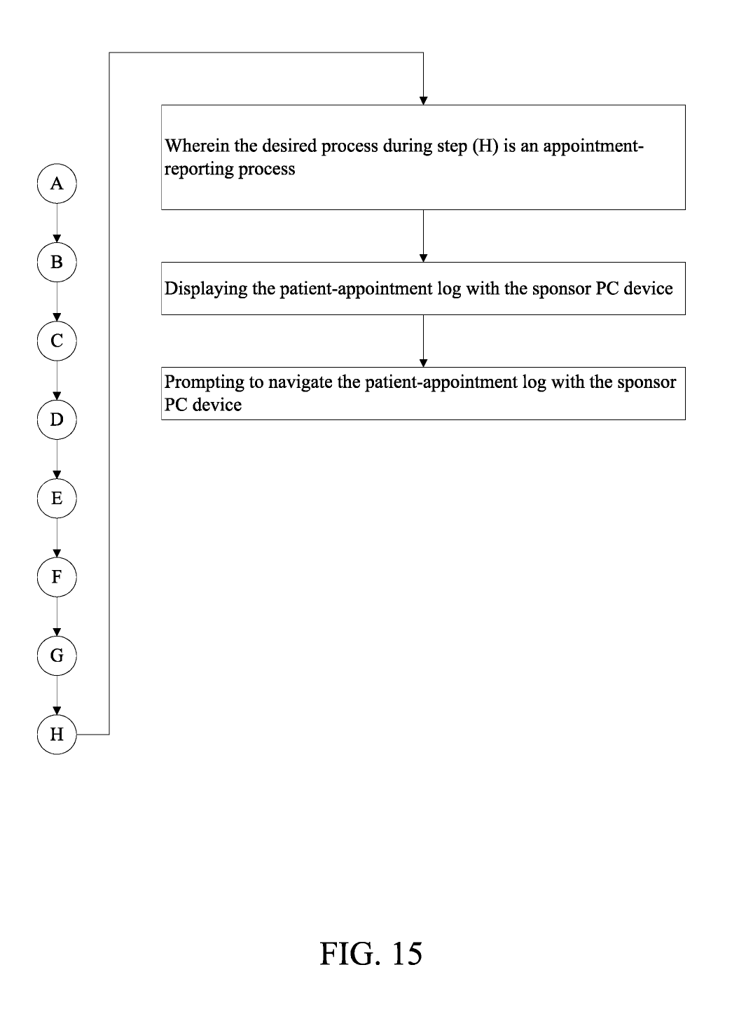

As can be seen in FIG. 15, the method of the present invention includes a sub-process that enables the clinical-trial sponsor to view the appointments that are stored in the subject-appointment log of any of the active sites associated to the clinical-trial sponsor. This sub-process is initiated when the desired process during Step H is an appointment-reporting process. The sub-process begins by displaying the subject-appointment log with the sponsor PC device. The sub-process then prompts to navigate the subject-appointment log with the sponsor PC device. The clinical-trial sponsor is then able to perform various operations on the subject-appointment log including, but not limited to, searching for a specific appointment, finding the appointments for a specific clinician, and removing canceled appointments.

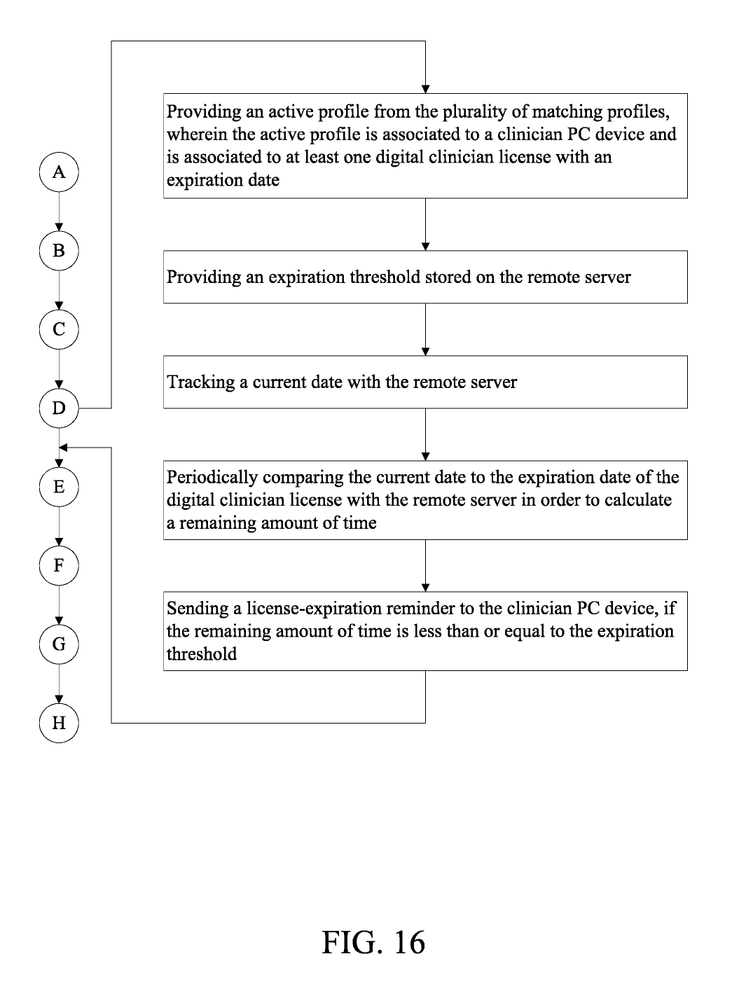

As can be seen in FIG. 16, the method of the present invention includes a sub-process for generating alerts when a clinician's medical license is about to expire. This sub-process ensures that all the clinicians associated to each clinical-trial site have up to date licenses and are authorized to practice. Specifically, the active profile is associated to a clinician PC device and is associated to at least one digital clinician license with an expiration date. Accordingly, the digital clinician license is a record that contains the clinician's licensing information. Additionally, the sub-process provides an expiration threshold stored on the remote server. The expiration threshold defines a period of time that triggers an alert message. Specifically, the sub-process begins by tracking a current date with the remote server. The sub-process continues by periodically comparing the current date to the expiration date of the digital clinician license with the remote server in order to calculate a remaining amount of time. The remaining amount of time is the number of days that exist between the current date and the expiration date. This comparison enables the sub-process to identify when a clinician is in danger of becoming unlicensed due to expiration. The sub-process concludes by sending a license-expiration reminder to the clinician PC device, if the remaining amount of time is less than or equal to the expiration threshold. Consequently, the clinician is kept abreast of an impending expiration date, and able to take steps to prevent the clinical license from lapsing. In addition to checking for soon-to-expire clinician licenses, the method of the present invention includes a sub-process to check if the clinician has had their license to practice revoked. To accomplish this, the sub-process communicates with an external licensing server that contains licensing-status information. The licensing-status information contains the status—whether active or revoked—of the clinician's medical license. The sub-process searches through the licensing-status information to determine if the clinician's digital medical license is active or revoked. If the digital medical license is revoked, then the sub-process generates an alert that is sent to the clinical-trial site and the clinical-trial sponsor.

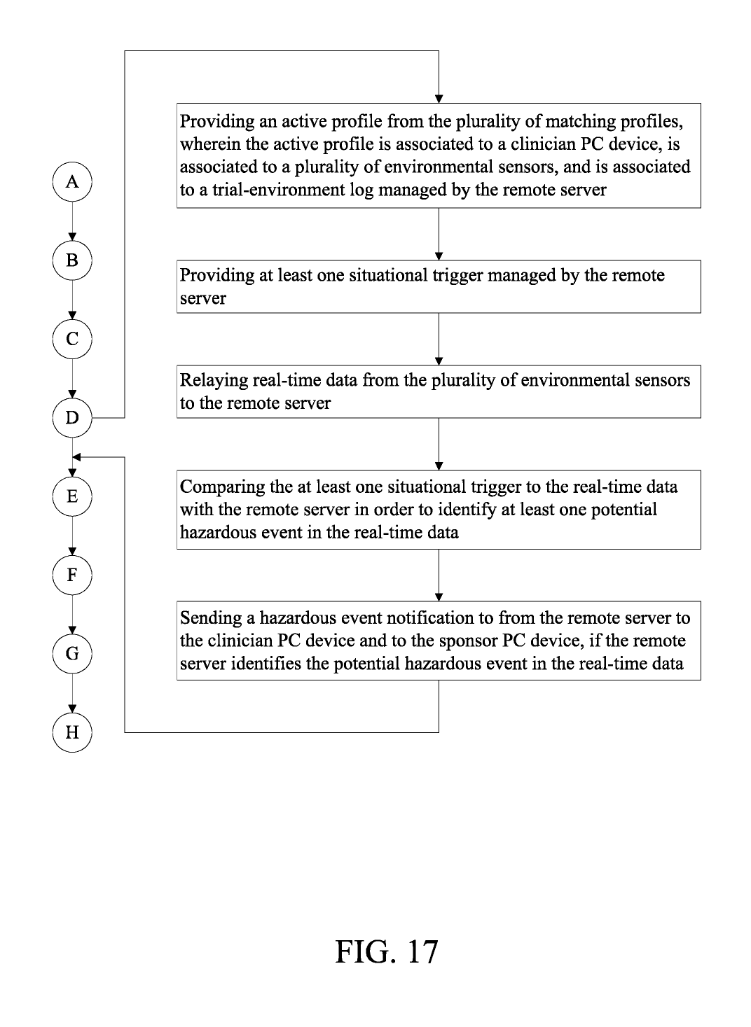

As can be seen in FIG. 17, the method of the present invention includes a sub-process for tracking various environmental sensors, which may be pertinent to performing the desired clinical trial. To facilitate this functionality, the system required to execute the method of the present invention provides a plurality of environmental sensors that are associated to the active profile, and a trial-environment log managed by the remote server. The plurality of environmental sensors is a collection of environmental sensors that includes, but is not limited to, temperature sensors, motion sensors, biometric sensors, and vital-sign-monitoring sensors. Additionally, the system provides at least one situational trigger managed by the remote server. The situational trigger is a user-defined event that, when detected by the plurality of environmental sensors, will trigger a series of alert messages and dependent sub-routines. Given this technical backdrop, the sub-process for tracking environmental sensors begins by relaying real-time data from the plurality of environmental sensors to the remote server. The real-time data is the data that is output by the plurality of environmental sensors. This data contains all the information that the plurality of environmental sensors has gathered about the external world, or the closed environments that are being monitored. The sub-process continues by comparing the at least one situational trigger to the real-time data with the remote server in order to identify at least one potential hazardous event in the real-time data. Accordingly, the sub-process constantly checks the data being output by the plurality of environmental sensors to identify if something has gone wrong, or if the clinical trial is somehow in jeopardy due to environmental factors. The sub-process concludes by sending a hazardous event notification to from the remote server to the clinician PC device and to the sponsor PC device, if the remote server identifies the potential hazardous event in the real-time data. As a result, the clinical-trial sponsor, and the clinical-trial site are alerted to any possible problems. The method of the present invention enables the clinical-trial sponsor and the clinical-trial site to view a record of all the data that was output by the plurality of environmental sensors. This enables the clinical-trial sponsor and the clinical-trial site to run longitudinal studies of the environmental sensor data.

In addition to managing communications and contracts, the method of the present invention enables the clinical-trial sponsor to give varying permissions and access rights to the medical professionals who are employed at the active sites. This is accomplished by a delegation of authority process. In the delegation of authority process, a primary investigator (PI) who is in charge of the clinical trial being performed at an active site is able to assign tasks to individuals by using the method of the present invention. As a result, the PI is able to institute a hierarchical chain of command for the clinical professionals at a clinical-trial site. That is, subordinate professionals must seek approval from higher-ranking professionals when performing various tasks. Additionally, the higher-ranking professionals function as points of contact for relaying information to and from the PI. The present invention also includes a sub-process that enables clinicians to recommend patients and other clinicians be included in the clinical trial being performed. The present invention further improves clinical trials management operations by enabling to integration with existing electronic medical record (EMR) solutions. This enables clinical-trial sites to search through EMR data based on multi-value filters. The present invention will be able to generate various EMR reports that are structured around the clinical-trial site's filters. These reports can include, but are not limited to, a count of available subjects, a listing of subject identifiers, and a dashboard breakdown of the multi-valued filters.

Although the invention has been explained in relation to its preferred embodiment, it is to be understood that many other possible modifications and variations can be made without departing from the spirit and scope of the invention as hereinafter claimed.

What is claimed is:

1. A method of facilitating data-exchange between clinical-trial sites and clinical-trial sponsors, the method comprises of the steps of:
(A) providing a plurality of site profiles managed by at least one remote server, wherein each site profile includes capability data;
(B) providing a plurality of trial-facilitation processes stored on the remote server;
(C) retrieving at least one sponsor request from an external server with the remote server, wherein the sponsor request includes a plurality of inclusion-exclusion criteria and sponsor contact information;
(D) comparing the inclusion-exclusion criteria to the capability data of each site profile with the remote server in order to identify a plurality of matching profiles for the sponsor request, wherein the plurality of matching profiles is from the plurality of site profiles;
(E) sending a participation request to the sponsor contact information with the remote server, wherein the participation request discloses the matching profiles;
(F) generating a sponsor account for the sponsor request with the remote server, if the remote server receives a response for the participation request, wherein the sponsor account is associated to a sponsor personal computing (PC) device;
(G) prompting the sponsor account to select a desired process from the plurality of trial-facilitation processes with the sponsor PC device;
(H) executing the desired process with the remote server, if the desired process is selected from the plurality of trial-facilitation processes by the sponsor PC device;

2. The method of facilitating data-exchange between clinical-trial sites and clinical-trial sponsors, the method as claimed in claim 1 comprises the steps of:
assessing a favorability score for each matching profile in accordance to the inclusion-exclusion criteria with the remote server before step (E);
integrating the favorability score for each matching profile into the participation request with the remote server;

3. The method of facilitating data-exchange between clinical-trial sites and clinical-trial sponsors, the method as claimed in claim 1 comprises the steps of:
providing a plurality of clinician PC devices, wherein each site profile is associated to at least one corresponding device from the plurality of clinician PC devices;
sending a feasibility questionnaire to the corresponding device with the remote server;
relaying resource data as a response to the feasibility questionnaire from the corresponding device to the remote server;
designating the resource data as the capability data for each site profile with the remote server;

4. The method of facilitating data-exchange between clinical-trial sites and clinical-trial sponsors, the method as claimed in claim 1 comprises the steps of:
(I) wherein the desired process during step (H) is a profile-selection process;
(J) providing at least one clinician PC device for each of the plurality of site profiles;
(K) enabling communication between the sponsor PC device and the clinician PC device for each matching profile through the remote server;
(L) prompting the sponsor account to send a contract to the clinician PC device of at least one desired profile, wherein the desired profile is from the plurality of matching profiles;
(M) displaying the contract on the clinician PC device;
(N) designating the desired profile as an active profile for the sponsor account with the remote server, if the contract is accepted and returned by the clinician PC device of the desired profile;

5. The method of facilitating data-exchange between clinical-trial sites and clinical-trial sponsors, the method as claimed in claim 4 comprises the steps of:
providing each of the plurality of site profiles with at least one subject contact information stored on the remote server;
executing a contract-renegotiation process between the sponsor PC device and the clinician PC device in order to identify at least one informed consent amendment;
sending the informed consent amendment to the contract from the remote server to the subject contact information;

6. The method of facilitating data-exchange between clinical-trial sites and clinical-trial sponsors, the method as claimed in claim 1 comprises the steps of:
wherein the desired process during step (H) is a sponsor-coaching process;
providing a plurality of sponsor-coaching resources stored on the remote server;
prompting to select a desired resource from the plurality of sponsor-coaching resources with the sponsor PC device;
outputting the desired resource with the sponsor PC device;

7. The method of facilitating data-exchange between clinical-trial sites and clinical-trial sponsors, the method as claimed in claim 1 comprises the steps of:
providing a plurality of clinician-coaching resources stored on the remote server;
providing an active profile from the plurality of matching profiles, wherein the active profile is associated to a clinician PC device;
prompting to select a desired resource from the plurality of clinician-coaching resources with the clinician PC device;
outputting the desired resource with the clinician PC device;

8. The method of facilitating data-exchange between clinical-trial sites and clinical-trial sponsors, the method as claimed in claim 1 comprises the steps of:
providing an active profile from the plurality of matching profiles, wherein the active profile is associated to a clinician PC device and is associated to a trial-data log managed by the remote server;
prompting to enter at least one new trial-data entry with the clinician PC device;
appending the new trial-data entry into the trial-data log with the remote server;

9. The method of facilitating data-exchange between clinical-trial sites and clinical-trial sponsors, the method as claimed in claim 8 comprises the steps of:
wherein the desired process during step (H) is a data-reporting process;
relaying a data request from the sponsor PC device to the remote server;
extracting desired data from the trial-data log in accordance to the data request with the remote server;
compiling the desired data into a summarization report with the remote server;
outputting the summarization report with the sponsor PC device;

10. The method of facilitating data-exchange between clinical-trial sites and clinical-trial sponsors, the method as claimed in claim 8 comprises the steps of:
relaying a data request from the clinician PC device to the remote server;
extracting desired data from the trial-data log in accordance to the data request with the remote server;
compiling the desired data into a summarization report with the remote server;
outputting the summarization report with the clinician PC device;

11. The method of facilitating data-exchange between clinical-trial sites and clinical-trial sponsors, the method as claimed in claim 1 comprises the steps of:
providing an active profile from the plurality of matching profiles, wherein the active profile is associated to a clinician PC device and is associated to a subject-appointment log managed by the remote server;
providing at least one subject contact information associated to the active profile, wherein the at least one subject contact information is stored on the remote server;
relaying an appointment-setting message from the clinician PC device to the subject contact information through the remote server;
converting the appointment-setting message into a new appointment entry with the remote server, if the remote server receives a confirmation for the appointment-setting message;
appending the new appointment entry into the subject-appointment log with the remote server;

12. The method of facilitating data-exchange between clinical-trial sites and clinical-trial sponsors, the method as claimed in claim 11 comprises the steps of:
prompting to enter ancillary notes for a desired appointment entry through the clinician PC device;
appending the ancillary notes into the desired appointment entry with the remote server;

13. The method of facilitating data-exchange between clinical-trial sites and clinical-trial sponsors, the method as claimed in claim 11 comprises the steps of:
displaying the subject-appointment log with the clinician PC device;
prompting to navigate the subject-appointment log with the clinician PC device;

14. The method of facilitating data-exchange between clinical-trial sites and clinical-trial sponsors, the method as claimed in claim 11 comprises the steps of:
wherein the desired process during step (H) is an appointment-reporting process;
displaying the subject-appointment log with the sponsor PC device;
prompting to navigate the subject-appointment log with the sponsor PC device;

15. The method of facilitating data-exchange between clinical-trial sites and clinical-trial sponsors, the method as claimed in claim 1 comprises the steps of:
providing an active profile from the plurality of matching profiles, wherein the active profile is associated to a clinician PC device and is associated to at least one digital clinician license with an expiration date;
providing an expiration threshold stored on the remote server;
tracking a current date with the remote server;
periodically comparing the current date to the expiration date of the digital clinician license with the remote server in order to calculate a remaining amount of time;
sending a license-expiration reminder to the clinician PC device, if the remaining amount of time is less than or equal to the expiration threshold;

16. The method of facilitating data-exchange between clinical-trial sites and clinical-trial sponsors, the method as claimed in claim 1 comprises the steps of:
providing an active profile from the plurality of matching profiles, wherein the active profile is associated to a clinician PC device, is associated to a plurality of environmental sensors, and is associated to a trial-environment log managed by the remote server;
providing at least one situational trigger managed by the remote server;
relaying real-time data from the plurality of environmental sensors to the remote server;
comparing the at least one situational trigger to the real-time data with the remote server in order to identify at least one potential hazardous event in the real-time data;
sending a hazardous event notification to from the remote server to the clinician PC device and to the sponsor PC device, if the remote server identifies the potential hazardous event in the real-time data;
